(19) United States
(12) Patent Application Publication
(10) Pub. No.: US 2022/0230244 A1
(43) Pub. Date: Jul. 21, 2022

(54) ENERGY TRADING SYSTEM AND METHOD FOR PERFORMING ENERGY TRADING BETWEEN BLOCKCHAIN-BASED SERVERS

(71) Applicant: Electronics and Telecommunications Research Institute, Daejeon (KR)

(72) Inventors: Chang-Sic CHOI, Daejeon (KR); Tai-yeon KU, Daejeon (KR); Dae Geun PARK, Sejong-si (KR); Wan Ki PARK, Daejeon (KR)

(73) Assignee: Electronics and Telecommunications Research Institute, Daejeon (KR)

(21) Appl. No.: 17/525,215

(22) Filed: Nov. 12, 2021

(30) Foreign Application Priority Data
Jan. 19, 2021 (KR) 10-2021-0007369

(51) Int. Cl. G06Q 40/04; G06Q 50/06; G06Q 30/08; G06Q 30/02

(52) U.S. Cl. CPC G06Q 40/04; G06Q 50/06; G06Q 2220/00; G06Q 30/0206; G06Q 30/08

(57) ABSTRACT

An energy trading system and method for performing energy trading between blockchain-based servers are disclosed. Specifically, in the energy trading method, a blockchain transaction table is divided and operated into an energy channel and a trading channel for energy prosumer power trading, and a procedure for processing a transaction is provided through servers divided into an energy prosumer blockchain server, a power trading blockchain server, and an operator blockchain server.

### CROSS-REFERENCE TO RELATED APPLICATION

This application claims the benefit of Korean Patent Application No. 10-2021-0007369 filed on Jan. 19, 2021, in the Korean Intellectual Property Office, the entire disclosure of which is incorporated herein by reference for all purposes.

### BACKGROUND

### 1. Field of the Invention

One or more example embodiments relate to an energy trading system and method for performing energy trading between blockchain-based servers, and more specifically, to a system and method for supporting energy trading between servers for surplus power based on a blockchain platform.

### 2. Description of the Related Art

Recently, the installation and operation of new and renewable energy facilities in homes is increasing as a result of a policy to expand the supply of solar power generation facilities and a policy to expand the supply of new and renewable energy. A volume of generated new and renewable energy varies a lot depending on a climate and an operating environment, and energy is generated irrespective of energy consumption patterns of individual homes, and thus the generated energy is not used at home, and surplus power remains.

The surplus power is stored through an energy storage device. A gap may be filled by discharging and using energy, as necessary. However, there is difficulty with respect to the issue of cost when additional energy storage devices are installed in individual homes.

Therefore, energy utilization is maximized when a trading system capable of selling surplus power resulting from the generation of new and renewable energy to other energy consumer and prosumer households is built. Most of the conventional energy trading systems are compensated, sold, and brokered through large power sales operator such as Korea Electric Power Corporation or the Korea Power Exchange. However, there is a short-coming in that it is difficult to develop a flexible trading service and increase the cost for power trading between individuals and neighbors.

Due to such a short-coming, a study is being actively conducted on the configuration of a system for person-to-person trading. However, the system is based on the person-to-person trading, and thus it is required to resolve various security issues such as transparent disclosure of trading details, prevention of forgery and falsification of information such as a production volume and a trading volume, prevention of trading denial through authentication between trading parties, and the like.

### SUMMARY

Example embodiments provide a method for building and operating a private blockchain-based energy trading system including pre-approved energy prosumers and consumers so as to perform smooth energy trading between the energy prosumers.

Example embodiments provide a method for building a transparent energy trading service by solving a security issue that occurs in the process of performing energy trading through a blockchain-based distributed ledger technology, and using a distributed ledger shared between servers.

Example embodiments provide a method for supporting a more efficient blockchain-based system by using an energy channel including energy production and consumption information and a trading channel including sales and purchase energy information.

According to an aspect, there is provided an energy trading method performed by an energy prosumer blockchain server, the energy trading method including initializing a blockchain platform operated through the energy prosumer blockchain server, generating a blockchain-based energy channel for sharing energy status information in response to the initialization, receiving a transaction on energy status information from an energy prosumer client, and updating an energy distributed ledger to include the transaction.

The initializing may include initializing the blockchain platform to perform at least one of functions of a distributed ledger for blockchain-based energy trading, subscriber authentication, a consensus algorithm, and chain code application for transaction processing.

The receiving of the transaction may include receiving a transaction on energy status information including at least one of an energy production volume, an energy consumption volume, and an energy storage volume generated by an energy prosumer client.

The energy prosumer blockchain server may be configured to be linked with at least one of a power trading blockchain server and a utility operator blockchain server through an energy channel including blockchain-based energy information channel data to share the transaction included in the updated energy distributed ledger.

According to another aspect, there is provided an energy trading method performed by a power trading blockchain server, the energy trading method including initializing a blockchain platform operated through the power trading blockchain server, generating a blockchain-based energy channel for sharing energy status information in response to the initialization, generating a blockchain-based trading channel for sharing energy trading information based on the energy status information, and processing at least one of the energy status information or the energy trading information using a transaction in an energy distributed ledger through the energy channel.

The initializing may include initializing the blockchain platform to perform at least one of functions of a distributed ledger for blockchain-based energy trading, subscriber authentication, a consensus algorithm, and chain code application for transaction processing.

The processing may include inquiring energy status information for energy trading generated by a trading service client using the transaction in an energy prosumer blockchain server linked through the energy channel.

The processing may include registering energy trading information including at least one of energy bidding information, sales volume status information, purchase volume status information, and unit price information generated by a trading service client.

The power trading blockchain server may be configured to share energy status information with a power trading blockchain server and an operator blockchain server linked through the energy channel, and share energy trading information with an operator blockchain server linked through the trading channel.

According to still another aspect, there is provided an energy trading method performed by an operator blockchain server, the energy trading method including initializing a blockchain platform operated through the operator blockchain server, generating a blockchain-based energy channel for sharing energy status information in response to the initialization, generating a blockchain-based trading channel for sharing energy trading information based on the energy status information, and inquiring at least one of the energy status information and the energy trading information using a transaction in an energy distributed ledger through the energy channel.

The initializing may include initializing the blockchain platform to perform at least one of functions of a distributed ledger for blockchain-based energy trading, subscriber authentication, a consensus algorithm, and chain code application for transaction processing.

The inquiring may include inquiring energy status information in response to a request of a utility operator client using the transaction in an energy prosumer blockchain server linked through the energy channel.

The inquiring may include inquiring energy trading information in response to a request of an additional service operator client using the transaction in a power trading blockchain server linked through the trading channel.

The operator blockchain server may be configured to share energy status information with an energy prosumer blockchain server and a power trading blockchain server linked through the energy channel, and share energy trading information with the power trading blockchain server linked through the trading channel.

According to still another aspect, there is provided an energy prosumer blockchain server including a processor. The processor may be configured to initialize a blockchain platform operated through the energy prosumer blockchain server, generate a blockchain-based energy channel for sharing energy status information in response to the initialization, receive a transaction on energy status information from an energy prosumer client, and update an energy distributed ledger to include the transaction.

The processor may be configured to receive a transaction on energy status information including at least one of an energy production volume, an energy consumption volume, and an energy storage volume generated by an energy prosumer client.

The processor may be configured to be linked with at least one of a power trading blockchain server and a utility operator blockchain server through an energy channel including blockchain-based energy information channel data to share the transaction included in the updated energy distributed ledger.

According to still another aspect, there is provided a power trading blockchain server including a processor. The processor may be configured to initialize a blockchain platform operated through the power trading blockchain server, generate a blockchain-based energy channel for sharing energy status information in response to the initialization, generate a blockchain-based trading channel for sharing energy trading information based on the energy status information, and process at least one of the energy status information or the energy trading information using a transaction in an energy distributed ledger through the energy channel.

The processor may be configured to inquire energy status information for energy trading generated by a trading service client using the transaction in an energy prosumer blockchain server linked through the energy channel.

The processor may be configured to register energy trading information including at least one of energy bidding information, sales volume status information, purchase volume status information, and unit price information generated by a trading service client.

Additional aspects of example embodiments will be set forth in part in the description which follows and, in part, will be apparent from the description, or may be learned by practice of the disclosure.

According to example embodiments, the energy trading method may allow a private blockchain-based energy trading system including pre-approved energy prosumers and consumers to be built and operated so as to perform smooth energy trading between the energy prosumers.

According to example embodiments, the energy trading method may allow a transparent energy trading service to be built by solving a security issue that occurs in the process of performing energy trading through a blockchain-based distributed ledger technology, and using a distributed ledger shared between servers.

According to example embodiments, the energy trading method may allow a more efficient blockchain-based system to be supported by using an energy channel including energy production and consumption information and a trading channel including sales and purchase energy information.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an energy trading system according to an example embodiment;

FIG. 2 is a diagram illustrating a blockchain transaction table based on an energy channel and a trading channel according to an example embodiment; and

FIG. 3 is a flowchart illustrating an energy trading method through a plurality of servers according to an example embodiment.

### DETAILED DESCRIPTION

The following structural or functional descriptions of example embodiments described herein are merely intended for the purpose of describing the example embodiments described herein and may be implemented in various forms. However, it should be understood that these example embodiments are not construed as limited to the illustrated forms.

Various modifications may be made to the example embodiments. Here, the example embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” or “accessed” to another component, it may be understood that the one component is directly connected or accessed to another component or that still other component is interposed between the two components. In addition, it should be noted that if it is described in the specification that one component is “directly connected” or “directly joined” to another component, still other component may not be present therebetween. Likewise, expressions, for example, “between” and “immediately between” and “adjacent to” and “immediately adjacent to” may also be construed as described in the foregoing.

The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

In addition, terms such as first, second, A, B, (a), (b), and the like may be used herein to describe components. Each of these terminologies is not used to define an essence, order, or sequence of a corresponding component but used merely to distinguish the corresponding component from other component(s).

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Hereinafter, example embodiments will be described in detail with reference to the accompanying drawings. When describing the example embodiments with reference to the accompanying drawings, like reference numerals refer to like components and a repeated description related thereto will be omitted.

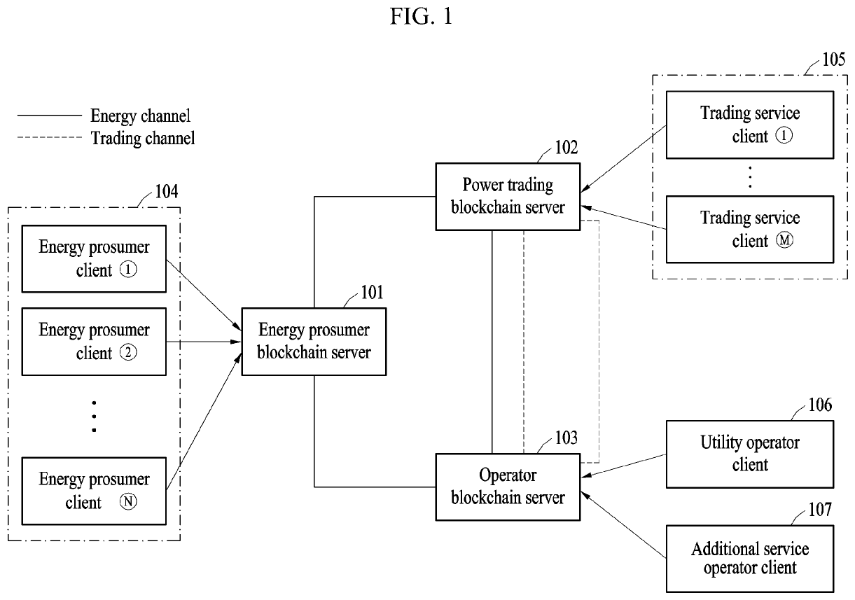

FIG. 1 is a diagram illustrating an energy trading system according to an example embodiment.

Referring to FIG. 1, example embodiments relate to a system for supporting trading with respect to surplus power produced in excess of a consumption volume in an energy prosumer housing environment capable of producing energy while consuming energy. According to example embodiments, it is possible to configure an energy trading system based on a blockchain platform to solve security issues such as integrity, confidentiality, authentication, and forgery and falsification of pieces of information on energy production, consumption and trading.

The blockchain platform may be a public blockchain in which anyone is able to participate and a private blockchain in which only an approved user is able to participate, depending on an application field and characteristics. Users participating in energy trading are limited to pre-approved prosumers, example embodiments may target a private blockchain platform technology.

According to example embodiments, it is possible to configure a plurality of blockchain servers divided according to a user type. Each of the plurality of blockchain servers may transmit and receive blockchain transaction data to and from an approved user and service, and then may share an energy distributed ledger with other servers. In addition, the blockchain servers may configure a multi-channel divided into an energy channel and a trading channel to prevent unnecessary information from being shared, reduce complexity of transaction processing, and increase processing performance.

According to example embodiments, it is possible to configure a multi-channel for interaction between respective servers and clients in a private blockchain-based system based on the blockchain servers.

More specifically, the energy trading system illustrated in FIG. 1 may include three independent servers that operate a private blockchain platform. The three independent servers may be divided into an energy prosumer blockchain server 101, a power trading blockchain server 102, and an operator blockchain server 103.

Each of the energy prosumer blockchain server 101, the power transaction blockchain server 102, and the operator blockchain server 103 may perform a role of providing an interface to pre-authenticated users or services, and processing individually generated transactions. In addition, according to example embodiments, a multi-channel divided into an energy channel and a transaction channel may be formed according to the purpose of an overall system including a plurality of servers, so that only servers participating in a corresponding channel may share and manage data of the corresponding channel.

\textcircled{1} Energy Prosumer Blockchain Server 101

An energy prosumer blockchain server 101 may process a transaction on pieces of energy-related information such as an energy production volume, consumption volume, storage volume. and the like. The energy prosumer blockchain server 101 may provide a transaction interface to an energy prosumer client 104. The energy prosumer client 104 may be generally operated by an energy metering device in an individual home. The energy prosumer client 104 may invoke a transaction API provided by the energy prosumer blockchain server 101 to process various pieces of energy metering information. The energy prosumer blockchain server 101 may perform most of one-way functions of recording metering information in a blockchain distributed ledger in response to the invocation of the energy prosumer client 104.

\textcircled{2} Power Trading Blockchain Server 102

A power trading blockchain server 102 may be in charge of energy trading information and manage the energy trading information. Target clients of the power trading blockchain server 102 may be trading service clients 105, and the trading service client 105 may be implemented as an application service program executed by an energy prosumer, consumer, operator, and the like that perform actual trading. That is, users execute the trading service client 105, and respective trading service clients may present, to the users, energy bidding information, sales volume/purchase volume status information, unit price information, and the like necessary for trading. The trading service client 105 may inquire necessary information or register trading information through a transaction with the power trading blockchain server 102.

In particular, it is required for the power trading blockchain server 102 to access energy information so as to understand energy status information for trading, and thus the power trading blockchain server 102 may subscribe to an energy channel in addition to a trading channel.

\textcircled{3} Operator Blockchain Server 103

An operator blockchain server 103 may be operated to subscribe to both an energy channel and a trading channel, and may perform a role of providing additional information to external operators 106 and 107. Therefore, the operator blockchain server 103 may be also restricted to perform only a function of inquiring energy and trading information.

In the energy channel, all three servers participating in a blockchain may be shared and managed. In addition, in the trading channel, it may be confirmed that the power trading blockchain server 102 participating in a trading service and the operator blockchain server 103 that inquires trading information are subscribed. Example embodiments that support such a multi-channel may be extended and applied to a system that accommodates various services and data, thereby improving data security and performance.

In addition, in configuring the multi-channel according to example embodiments, a size of a distributed ledger may be reduced, processing speed may be improved by allowing necessary services to access only necessary information, and unnecessary information caused by sharing the distributed ledger may be prevented from being shared.

In addition, servers equipped with a private blockchain platform may be divided and configured into a server 101 that is in charge of energy information of a prosumer, a server 102 connected to a trading service, and a server 103 that provides an interface with an external operator, according to a role, thereby simplifying an interface for clients, improving data processing speed, and securing information. Furthermore, according to example embodiments, unnecessary security costs may be reduced when building a personal trading system for surplus power between energy prosumers, and efficiency and security may be increased through division into energy information and transaction information and the servers divided according to a role.

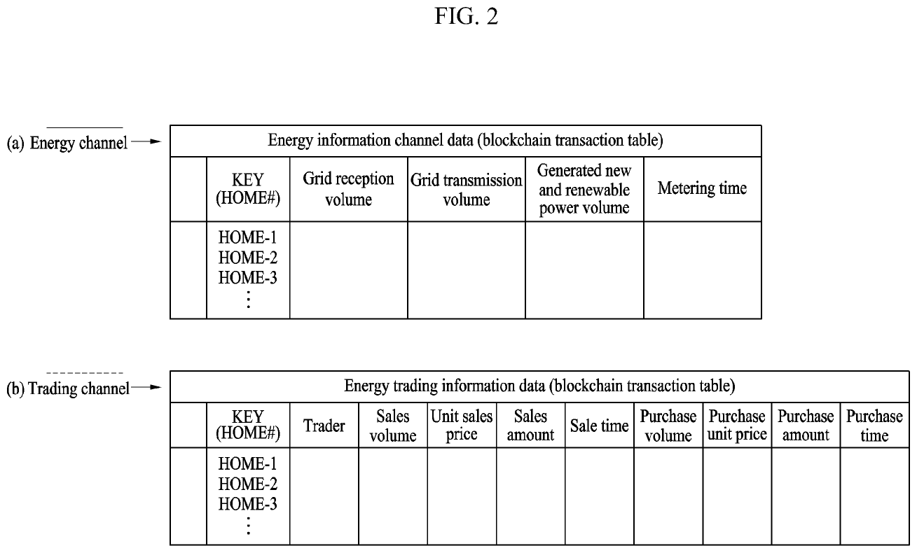

FIG. 2 is a diagram illustrating a blockchain transaction table based on an energy channel and a trading channel according to an example embodiment.

Referring to FIG. 2, according to example embodiments, a private blockchain-based multi-channel may be formed to build a free personal trading system between energy prosumers. The multi-channel may be divided into an energy channel and a trading channel according to purpose. In each channel, only servers participating for energy trading may share and manage data of a corresponding channel.

A blockchain transaction table processed in each channel of the multi-channel may have the following data structure, and may include different lists depending on shared and managed data.

\textcircled{1} Energy Channel

According to example embodiments, in an energy channel, various pieces of energy-related information such as a production volume, a consumption volume, a storage volume, and the like of an energy prosumer may be stored, shared, and managed in an energy distributed ledger.

A transaction and data structure processed in the energy channel may be presented in energy information channel data, as illustrated in FIG. 2A. The energy information channel data may include a KEY, a grid power reception volume, a grid transmission volume, a generated new and renewable power volume, and a metering time. Each data may be defined as follows.
KEY: An ID value of an individual home as a key value
Grid reception volume: A volume of power consumed from a grid
Grid transmission volume: A volume of power transmitted back to a grid
Generated new and renewable power volume: Information such as a volume of new and renewable power generated from a new and renewable power generation device such as solar power generation
Metering time: Information on time when information such as a generated new and renewable power volume is measured

\textcircled{2} Trading Channel

According to example embodiments, a trading channel may divide and manage pieces of information necessary for an energy trading service, such as a sales volume, a purchase volume, a trading price, energy information status inquiry, and the like.

A transaction and data structure processed in the trading channel may be presented in energy trading information data, as illustrated in FIG. 2B. The energy trading information data may include a KEY, a trader, a sales volume, a unit sales price, a sales amount, a sale time, a purchase volume, a purchase unit price, a purchase amount, and a purchase time. Each data may be defined as follows.
KEY: An ID value of an individual home as a key value
Trader, sales volume (total), sales unit price (per unit), and sale time: Information necessary to sell surplus power
Purchase volume, purchase unit price, purchase amount, and purchase time: Information necessary for power purchase trading

According to example embodiments, based on such information, a system for pre-approved energy prosumers and consumers may be built, various security issues may be resolved through a blockchain-based distributed ledger technology, and a transparent trading service may be built through a shared distributed ledger. According to example embodiments, the characteristics of a multi-channel and a multi-server may be supported to reduce complexity of an energy distributed ledger and network traffic due to the characteristics of a blockchain, to divide information into energy information and trading information, and to facilitate service development.

In addition, according to example embodiments, the multi-channel may be divided and processed into an energy channel that is in charge of energy production and consumption information and a trading channel that is in charge of sales and purchase energy information. In addition, according to example embodiments, respective servers equipped with a private blockchain may be divided to provide a subscriber interface, thereby preventing an excessive load on a blockchain system, improving processing speed, and efficiently managing provided information.

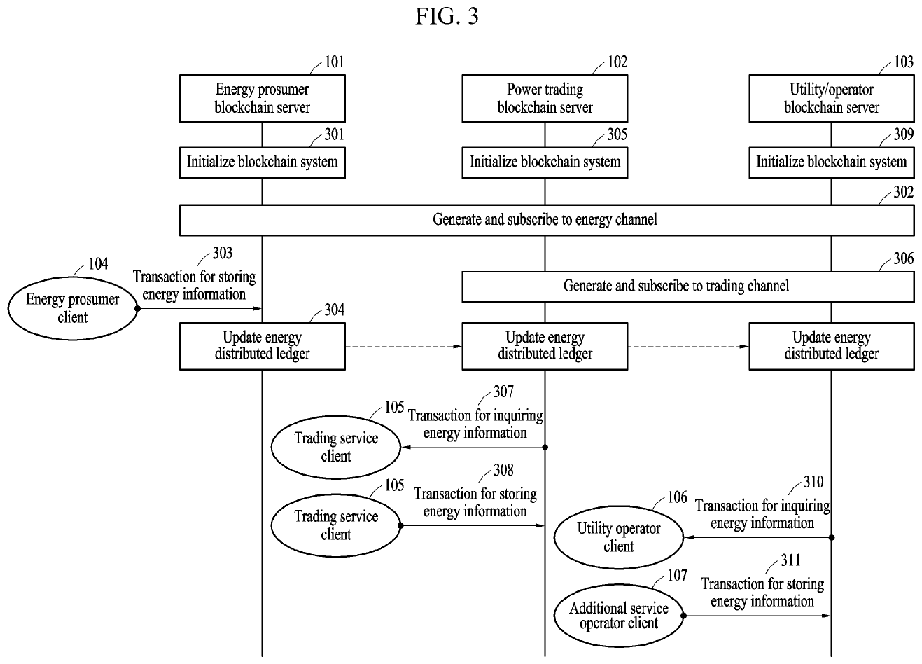

FIG. 3 is a flowchart illustrating an energy trading method through a plurality of servers according to an example embodiment.

Based on the flowchart of FIG. 3, FIG. 1 illustrates a process of processing transactions between a plurality of blockchain servers 101, 102, and 103 and clients respectively linked with the blockchain servers 101, 102, and 103. In addition, the flowchart of FIG. 3 may represent a procedure for configuring a multi-channel (energy channel and trading channel) formed in the blockchain servers 101, 102, and 103 for processing the transactions.

Here, the blockchain servers 101, 102, and 103, which are servers divided according to a role, may be operated independently. Each of the blockchain servers 101, 102, and 103 may be operated with a blockchain platform mounted thereon, and the blockchain platform may share and manage pieces of distributed ledger information between the blockchain servers.

In operation 301, the energy prosumer blockchain server 101 may initialize a blockchain platform operated through the energy prosumer blockchain server 101. An operation of initializing the blockchain platform may represent a process performed when the blockchain platform is started, and may be performed by the individual power trading blockchain server 102 and the operator blockchain server 103 as the same function, in addition to the energy prosumer blockchain server 101.

The energy prosumer blockchain server 101 may initialize the blockchain platform by performing at least one of a function of initializing a distributed ledger for blockchain-based energy trading, a subscriber authentication server function, a function of mounting a consensus algorithm, and a function of applying a chain code for transaction processing.

In operation 302, the energy prosumer blockchain server 101 may generate a blockchain-based energy channel for sharing energy status information in response to the initialization. Here, the energy channel may be a blockchain channel for sharing energy status information. The energy prosumer blockchain server 101 may represent a subscription process for accessing the energy channel.

In operation 303, the energy prosumer blockchain server 101 may receive a transaction on energy status information from the energy prosumer client 104. Here, the transaction may include the energy status information including at least one of an energy production volume, an energy consumption volume, and an energy storage volume generated by an energy prosumer client. In detail, the energy prosumer client 104 may periodically collect energy metering information from a meter installed in an individual home. The energy prosumer client 104 may transmit, based on the collected energy metering information, the transaction on the energy status information to the energy prosumer blockchain server 101.

In operation 304, the energy prosumer blockchain server 101 may update the energy distributed ledger to include the transaction. Here, the energy prosumer blockchain server 101 may be linked with at least one of the power trading blockchain server 102 and the utility operator blockchain server 103 through the energy channel to share the transaction included in the updated energy distributed ledger. In this case, a function of updating the energy distributed ledger may be performed by all servers subscribed to the energy channel.

In operation 305, the power trading blockchain server 102 may initialize the blockchain platform operated through the power trading blockchain server 102. An operation of initializing the blockchain platform may represent a process performed when the blockchain platform is started.

After performing the initialization operation, the power trading blockchain server 102 may generate a blockchain-based energy channel for sharing the energy status information in response to the initialization. The power trading blockchain server 102 may represent a subscription process for accessing the energy channel.

In operation 306, the power trading blockchain server 102 may generate a blockchain-based trading channel for sharing energy trading information based on the energy status information. Here, the trading channel may be a blockchain channel to which the power trading blockchain server 102 and the operator blockchain server 103 are accessible.

Accordingly, the trading channel may perform a function of sharing and managing energy trading information for confirming trading for surplus power generated by the energy prosumer client 104. The power trading blockchain server 101 may perform a subscription procedure for the trading channel.

The power trading blockchain server 102 may share the energy distributed ledger updated by at least one of the energy prosumer blockchain server 102 and the utility operator blockchain server 103 through the energy channel. The power trading blockchain server 102 may share the energy status information using the transaction in the energy distributed ledger through the energy channel.

In operation 307, the power trading blockchain server 102 may inquire energy status information for energy trading generated by the trading service client 105 using the transaction in the energy prosumer blockchain server 101 linked through the energy channel.

In operation 308, the power trading blockchain server 102 may register energy trading information including at least one of energy bidding information, sales volume status information, purchase volume status information, and unit price information generated by the trading service client 105. The trading service client 105 may transmit a transaction on the energy trading information to the power trading blockchain server 102.

In detail, in order to collect energy status information necessary for executing a trading service, the trading service client 105 may inquire the energy status information using the transaction as in operation 307. When the energy status information is inquired, the trading service client 105 may transmit, to the power transaction blockchain server 102, a transaction for storing energy trading information generated by a subscriber. Then, the power trading blockchain server 102 may update the energy distributed ledger to include the transaction on the energy trading information received from the trading service client 105.

The power transaction blockchain server 102 may share the energy status information with the energy prosumer blockchain server 101 and the operator blockchain server 103 linked through the energy channel, and may share the energy trading information with the operator blockchain server 103 linked through the trading channel.

In operation 309, the operator blockchain server 103 may initialize a blockchain platform operated through the operator blockchain server 103. An operation of initializing the blockchain platform may represent a process performed when the blockchain platform is started.

After performing the initialization operation, the operator blockchain server 103 may generate a blockchain-based energy channel for sharing energy status information in response to the initialization. The operator blockchain server 103 may represent a subscription process for accessing the energy channel. The operator blockchain server 103 may share the energy distributed ledger updated by at least one of the energy prosumer blockchain server 101 and the power trading blockchain server 102 through the energy channel.

In addition, the operator blockchain server 103 may generate a blockchain-based trading channel for sharing energy trading information based on the energy status information. The operator blockchain server 103 may perform a subscription procedure for the trading channel. The operator blockchain server 103 may share energy trading information with the power trading blockchain server 102 linked through the trading channel.

The operator blockchain server 103 may inquire at least one of the energy status information or the energy trading information using the transaction in the energy distributed ledger through the energy channel. Here, the operator blockchain server 103 may operate in linkage with a utility operator client 106 and an additional service operator client 107.

In operation 310, the operator blockchain server 103 may inquire the energy status information in response to a request of the utility operator client 106 using the transaction in the energy prosumer blockchain server 101 linked through the energy channel. For example, the utility operator client 106 may perform the transaction to collect energy status information for pieces of energy metering information through the operator blockchain server 103.

In operation 311, the operator blockchain server 103 may inquire the energy trading information in response to a request of the additional service operator client 107 using the transaction in the power trading blockchain server 102 linked through the trading channel. For example, the additional service operator client 107 may perform the transaction for inquiring the energy trading information to determine a trading information status.

An energy trading method for an energy prosumer according to example embodiments may be a person-to-person trading system, and thus may resolve various security issues such as transparent disclosure of trading details, prevention of forgery and falsification of information such as a production volume and a trading volume, and prevention of trading denial through authentication between trading parties. In addition, the energy trading method may use a blockchain platform to resolve the security issues.

In addition, the energy trading method of the energy prosumer may record energy production and consumption volume information, and energy trading volume information of individual energy prosumers in an energy distributed ledger. The energy distributed ledger may include the same ledger that is distributed and stored in blockchain operating nodes, and may be shared by an individual participant, thereby enabling the operation of a transparent trading system.

In addition, according to example embodiments, participant authentication may be performed through the operation of a certificate-based authentication technology, and thus a function of preventing denial for processing of a transaction on the energy distributed ledger may be performed. Pieces of individual energy information may be managed in the form of a block, and respective blocks may be connected and managed in the form of a chain, thereby blocking a forgery and falsification operation.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. An energy trading method performed by an energy prosumer blockchain server, the energy trading method comprising:
initializing a blockchain platform operated through the energy prosumer blockchain server;
generating a blockchain-based energy channel for sharing energy status information in response to the initialization;
receiving a transaction on energy status information from an energy prosumer client; and
updating an energy distributed ledger to include the transaction.

2. The energy trading method of claim 1, wherein the initializing comprises initializing the blockchain platform to perform at least one of functions of a distributed ledger for blockchain-based energy trading, subscriber authentication, a consensus algorithm, and chain code application for transaction processing.

3. The energy trading method of claim 1, wherein the receiving of the transaction comprises receiving a transaction on energy status information including at least one of an energy production volume, an energy consumption volume, and an energy storage volume generated by an energy prosumer client.

4. The energy trading method of claim 1, wherein the energy prosumer blockchain server is configured to be linked with at least one of a power trading blockchain server and a utility operator blockchain server through an energy channel including blockchain-based energy information channel data to share the transaction included in the updated energy distributed ledger.

5. An energy trading method performed by a power trading blockchain server, the energy trading method comprising:
initializing a blockchain platform operated through the power trading blockchain server;
generating a blockchain-based energy channel for sharing energy status information in response to the initialization;
generating a blockchain-based trading channel for sharing energy trading information based on the energy status information; and
processing at least one of the energy status information or the energy trading information using a transaction in an energy distributed ledger through the energy channel.

6. The energy trading method of claim 5, wherein the initializing comprises initializing the blockchain platform to perform at least one of functions of a distributed ledger for blockchain-based energy trading, subscriber authentication, a consensus algorithm, and chain code application for transaction processing.

7. The energy trading method of claim 5, wherein the processing comprises inquiring energy status information for energy trading generated by a trading service client using the transaction in an energy prosumer blockchain server linked through the energy channel.

8. The energy trading method of claim 5, wherein the processing comprises registering energy trading information including at least one of energy bidding information, sales volume status information, purchase volume status information, and unit price information generated by a trading service client.

9. The energy trading method of claim 5, wherein the power trading blockchain server is configured to:
share energy status information with an energy prosumer blockchain server and an operator blockchain server linked through the energy channel, and
share energy trading information with an operator blockchain server linked through the trading channel.

10. An energy trading method performed by an operator blockchain server, the energy trading method comprising:
initializing a blockchain platform operated through the operator blockchain server;
generating a blockchain-based energy channel for sharing energy status information in response to the initialization;
generating a blockchain-based trading channel for sharing energy trading information based on the energy status information; and
inquiring at least one of the energy status information and the energy trading information using a transaction in an energy distributed ledger through the energy channel.

11. The energy trading method of claim 10, wherein the initializing comprises initializing the blockchain platform to perform at least one of functions of a distributed ledger for blockchain-based energy trading, subscriber authentication, a consensus algorithm, and chain code application for transaction processing.

12. The energy trading method of claim 10, wherein the inquiring comprises inquiring energy status information in response to a request of a utility operator client using the transaction in an energy prosumer blockchain server linked through the energy channel.

13. The energy trading method of claim 10, wherein the inquiring comprises inquiring energy trading information in response to a request of an additional service operator client using the transaction in a power trading blockchain server linked through the trading channel.

14. The energy trading method of claim 10, wherein the operator blockchain server is configured to:
share energy status information with an energy prosumer blockchain server and a power trading blockchain server linked through the energy channel, and
share energy trading information with the power trading blockchain server linked through the trading channel.
